(19) United States
(12) Patent Application Publication
(10) Pub. No.: US 2007/0226697 A1
(43) Pub. Date: Sep. 27, 2007

(54) Autonomic performance management

(75) Inventors: Eric L. Barsness, Pine Island, MN (US); John M. Santosuosso, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/388,008

(22) Filed: Mar. 23, 2006

(51) Int. Cl. G06F 9/44

(52) U.S. Cl. 717/127

(57) ABSTRACT

Methods, apparatus, and computer program products are disclosed for autonomic performance management by selecting a performance management function, identifying a set of instructions capable of being analyzed using the performance management function, and determining whether to execute the performance management function on the identified set of instructions in dependence upon historical performance data of the identified set of instructions.

### BACKGROUND OF THE INVENTION

1. Field of the Invention

The field of the invention is data processing, or, more specifically, methods, apparatus, and products for autonomic performance management.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer software has become more sophisticated, the need for powerful performance tools to analyze computer software has increased. Performance tools have several key modes of operation and are often divided into three major categories. The first category of performance tools is trace performance tools. Trace performance tools track the details associated with executing each computer program instruction of a particular computer software application. For example, the trace performance tools may track the value of a variable before and after the execution of a computer program instruction accessing the variable. The second category of performance tools is sampling performance tools. Sampling performance tools sample a predefined performance metric at user defined time intervals. For example, a sampling performance tools may execute every five milliseconds to determine what process the CPU is executing. The third category of performance tools is statistics performance tools. Statistics performance tools typically collect data at the entry and exit of methods or procedures in a computer software application. For example, statistics performance tools may measure the amount of processor time utilized when executing a particular method or procedure of a computer software application.

Computer software architects utilizing statistics performance tools face certain challenges. Often, the overhead of collecting data at the entry and exit of every method or procedure in a computer software application is simply too high to warrant collecting the data. Collecting data every time a method or procedure joins or leaves the execution stack will often negatively affect the performance of the computer software application and present an overwhelming amount of data for a computer software architect to analyze. One mechanism to reduce the overhead of utilizing statistics performance tools is the use of filters. Filters allow a computer software architect to collect data only on a particular portion of computer software applications. For example, in Java, filters allow a computer software architect to collect data on individual classes, packages or methods. In other programming languages, filters allow a computer software architect to collect data on individual libraries. When deployed properly, these filters help reduce the amount of data collected with statistics performance tools. Often, however, these filters still collect performance data on methods or procedures whose overhead outweighs the benefit of the performance data collected.

### SUMMARY OF THE INVENTION

Methods, apparatus, and computer program products are disclosed for autonomic performance management by selecting a performance management function, identifying a set of instructions capable of being analyzed using the performance management function, and determining whether to execute the performance management function on the identified set of instructions in dependence upon historical performance data of the identified set of instructions.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in autonomic performance management according to embodiments of the present invention.

FIG. 2 sets forth a block diagram illustrating an exemplary system for autonomic performance management according to embodiments of the present invention.

FIG. 3 sets forth a flow chart illustrating an exemplary method for autonomic performance management according to embodiments of the present invention.

FIG. 4 sets forth a flow chart illustrating another exemplary method for autonomic performance management according to embodiments of the present invention.

FIG. 5 sets forth a flow chart illustrating another exemplary method for autonomic performance management according to embodiments of the present invention.

FIG. 6 sets forth a flow chart illustrating another exemplary method for autonomic performance management according to embodiments of the present invention.

FIG. 7 sets forth a flow chart illustrating another exemplary method for autonomic performance management according to embodiments of the present invention.

### DETAILED DESCRIPTION OF EXEMPLARY EMBODIMENTS

### Detailed Description

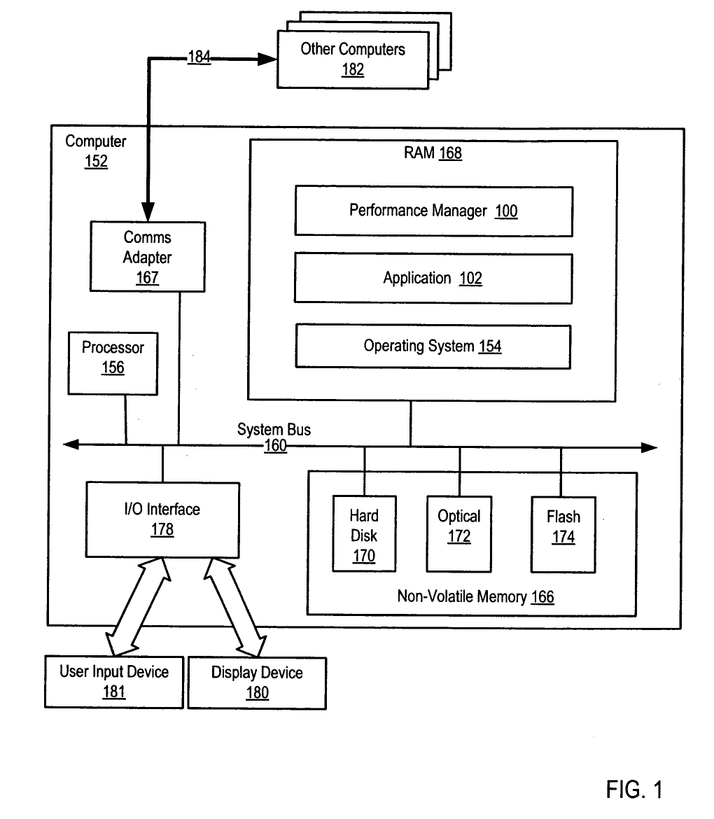

Exemplary methods, apparatus, and products for autonomic performance management according to embodiments of the present invention are described with reference to the accompanying drawings, beginning with FIG. 1. The term ‘autonomic’ refers to a computing process that behaves like a human being. Autonomic performance management in accordance with the present invention is generally implemented with computers, that is, with automated computing machinery. FIG. 1, therefore sets forth a block diagram of automated computing machinery comprising an exemplary computer (152) useful in autonomic performance management according to embodiments of the present invention. The computer (152) of FIG. 1 includes at least one computer processor (156) or ‘CPU’ as well as random access memory (168) (‘RAM’) which is connected through a system bus (160) to processor (156) and to other components of the computer.

Stored in RAM (168) is a performance manager (100), a set of computer program instructions improved for autonomic performance management according to embodiments of the present invention. The performance manager (100) analyzes the performance of a set of instructions of a computer software application using performance management functions. A set of instruction is an aggregation of one or more computer program instructions into a logical group. Examples of a set of instructions useful in autonomic performance management according to embodiments of the present invention include procedures, functions, or methods of a computer software application. Performance management functions useful for autonomic performance management according to embodiments of the present invention may include, for example, functions that identify the number of computer program instructions in a set of instructions of a computer software application, the amount of processing time utilized by a set of instructions of a computer program application, the amount of memory required to execute a set of instructions of a computer program application, and so on.

In the example of FIG. 1, the performance manager (100) operates generally for autonomic performance management according to embodiments of the present invention by selecting a performance management function, identifying a set of instructions capable of being analyzed using the performance management function, and determining whether to execute the performance management function on the identified set of instructions in dependence upon historical performance data of the identified set of instructions.

Also stored in RAM (168) is an application (102) and an operating system (154). The application (102) is computer program instructions for user-level data processing implementing threads of execution. Operating systems useful in computers according to embodiments of the present invention include UNIX™, Linux™, Microsoft XP™, AIX™, IBM's i5/OS™, and others as will occur to those of skill in the art. Operating system (154), application (102), and performance manager (100) in the example of FIG. 1 are shown in RAM (168), but many components of such software typically are stored in non-volatile memory (166) also.

Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 1 includes a communications adapter (167) for implementing data communications (184) with other computers (182). Such data communications may be carried out serially through RS-232 connections, through external buses such as the Universal Serial Bus (‘USB’), through data communications networks such as Internet Protocol (‘IP’) networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

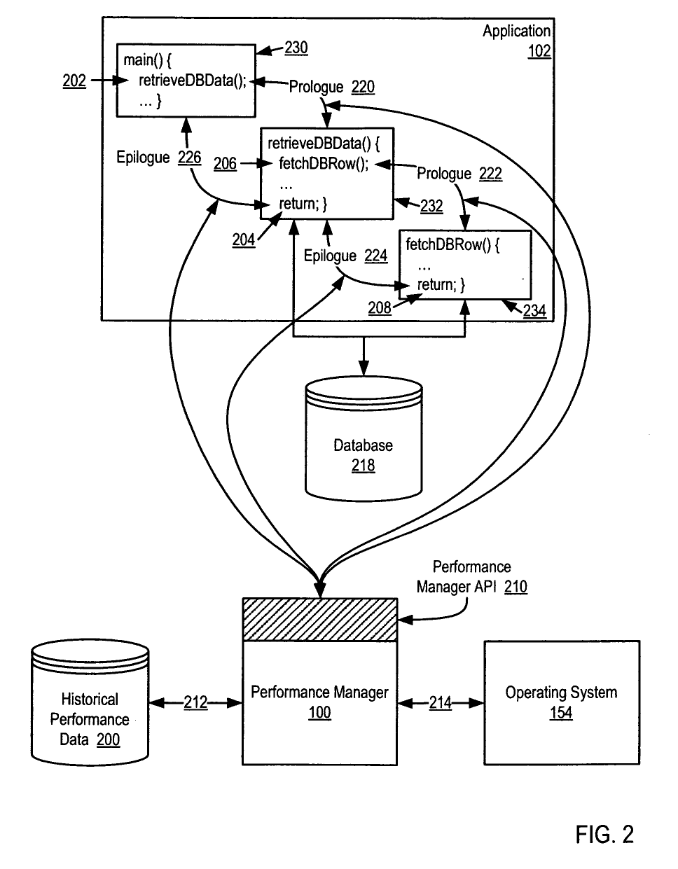

For further explanation, FIG. 2 sets forth a block diagram illustrating an exemplary system for autonomic performance management according to embodiments of the present invention. The system of FIG. 2 operates generally for autonomic performance management according to embodiments of the present invention by selecting a performance management function, identifying a set of instructions capable of being analyzed using the performance management function, and determining whether to execute the performance management function on the identified set of instructions in dependence upon historical performance data of the identified set of instructions.

The system of FIG. 2 includes an application (102). The application (102) is computer program instructions for user-level data processing implementing threads of execution. Specifically, the computer program instructions of application (102) depicted in the example of FIG. 2 is computer program instructions organized in to sets of instructions (230-234) that retrieve data from a database (218). Each set of instructions (230-234) is an aggregation of one or more computer program instructions into a logical group. In the example of FIG. 2, the sets of instructions (230-234) of application (102) are organized into functions labeled ‘main( ),’ ‘retrieveDBData ( ),’ and ‘fetchDBRow( ).’ The ‘main( )’ function includes a calling instruction (202) that transfers execution control of a processor from the set of instructions labeled ‘main( )’ to the set of instructions labeled ‘retrieveDBData( ).’ The ‘retrieveDBData( )’ function includes a calling instruction (206) that transfers execution control of a processor from the set of instructions labeled ‘retrieveDBData( )’ to the set of instructions labeled ‘fetchDBRow( ).’ At the end of the ‘fetchDBRow( )’ function, the ‘fetchDBRow( )’ function includes a return instruction (208) that transfers processor control back to the set of instructions labeled ‘retrieveDBData( ).’ Similarly, the ‘retrieveDBData( )’ function includes a return instruction (204) that transfers processor control back to the set of instructions labeled ‘main( ).’

The example of FIG. 2 depicts each set of instructions (230-234) labeled ‘main( ),’ ‘retrieveDBData( ),’ and ‘fetchDBRow( )’ as computer source code instructions set forth for explanation, rather than as a working model. The computer source code instructions depicted in the example of FIG. 2 are a high-level symbolic representation of machine code instructions executable by a computer processor. Computer source code instructions are translated into executable machine code instructions by a computer program called a ‘compiler.’ A compiler is computer software that translates computer program instructions written in one computer language into another computer language. Such computer languages translated by a compiler may include, for example, C++, C#, COBAL, Java, Fortran, assembly language, machine code, and so on.

When a compiler translates a set of computer program instructions written in source code into machine code, the compiler inserts a ‘prologue’ at the beginning of the compiled set of instructions and appends an ‘epilogue’ at the end of the compiled set of instructions. The prologue is computer program instructions that prepare the processor to execute the set of instructions associated with the prologue by pushing a new stack frame on the processor's execution stack and initializing the processor's registers. The epilogue is computer program instructions that prepare the processor to resume execution of a set of instructions that called the set of instructions associated with the epilogue. The epilogue restores the execution stack and processor registers back to the state before a calling instruction transferred processor control to the set of instructions associated with the epilogue. In the example of FIG. 2, therefore, after the processor executes the calling instruction (202) labeled ‘retrieveDBData( )’ in the set of instructions (230) labeled ‘main( ),’ the processor executes the prologue (220) for the set of instructions (232) labeled ‘retrieveDBData( ).’ Similarly, after the processor executes the calling instruction (206) labeled ‘fetchDBRow( )’ in the set of instructions (232) labeled ‘retrieveDBData( ),’ the processor executes the prologue (222) for the set of instructions (234) labeled ‘fetchDBRow( ).’ After the processor executes the return instruction (208) in the set of instructions (234) labeled ‘fetchDBRow( ),’ the processor executes the epilogue (224) for the set of instructions (234) labeled ‘fetchDBRow( )’ before returning processor control to the set of instructions (232) labeled ‘retrieveDBData( ).’ Similarly, after the processor executes the return instruction (204) in the set of instructions (232) labeled ‘retrieveDBData( ),’ the processor executes the epilogue (226) for the set of instructions (232) labeled ‘retrieveDBData( )’ before returning processor control to the set of instructions (230) labeled ‘main( ).’

The system of FIG. 2 also includes a performance manager (100). The performance manager (100) is a set of computer program instructions improved for autonomic performance management according to embodiments of the present invention. The performance manager (100) analyzes the performance of a set of instructions of a computer software application using performance management functions. The performance manager (100) operates generally for autonomic performance management according to embodiments of the present invention by selecting a performance management function, identifying a set of instructions capable of being analyzed using the performance management function, and determining whether to execute the performance management function on the identified set of instructions in dependence upon historical performance data of the identified set of instructions. Examples of performance manager that may be improved for autonomic performance management according to embodiments of the present invention include the IBM® Performance Explorer, the HP Tru64 Unix® Performance Management tools, the ELM Performance Manager™, and so on.

In the system of FIG. 2, the performance manager (100) analyzes the performance of the sets (230-234) of instructions of application (102) by executing a performance management function when execution control transfers from one set of instructions of application (102) to another set of instructions of application (102). For example, in the system of FIG. 2, the performance manager (100) may execute a performance management function on the set of instructions (232) labeled ‘retrieveDBData( )’ when execution control passes from the set of instructions (230) labeled ‘main( )’ to the set of instructions (232) labeled ‘retrieveDBData( ),’ when execution control returns from the set of instructions (232) labeled ‘retrieveDBData( )’ to the set of instructions (230) labeled ‘main( ),’ when execution control passes from the set of instructions (232) labeled ‘retrieveDBData( )’ to the set of instructions (234) labeled ‘fetchDBRow( ),’ or when execution control returns from the set of instructions (234) labeled ‘fetchDBRow( )’ to the set of instructions (232) labeled ‘retrieveDBData( ).’

In order to execute a performance management function when execution control transfers from one set of instructions of application (102) to another set of instructions of application (102), the performance manager (100) must first obtain processor execution control itself. To allow a performance manager (100) to obtain execution control for executing a performance management function on a set of instructions, a compiler may insert instrumentation points into the prologue and epilogue for a compiled set of instructions. An instrumentation point is a calling instruction that transfers execution control from the prologue or epilogue of a set of instructions of an application (102) to the performance manager (100). To transfer execution control to the performance manager (100), the instrumentation point may be implemented as a calling instruction to a performance manager application programming interface (‘API’) (210). A performance manager API may be implemented as computer program instructions contained in a dynamically linked library available to the application (102) at run time. The performance manager API may also be implemented as computer program instructions contained in a statically linked library included in the performance manager (100) at compile time. In the example of FIG. 2, prologues (220, 222) and epilogues (224, 226) include instrumentation points that transfer execution control of a processor to the performance manager (100). The instrumentation points are implemented as calling instructions to a performance manager API (210) inserted into the application (102) by a compiler.

When a just-in-time (‘JIT’) compiler compiles a set of instructions, instrumentation points may be dynamically inserted into the prologue or epilogue of the set of instructions using dynamic byte-code instrumentation. Byte-code is an intermediate form of computer program code compiled from another computer program language, but more abstract than computer machine code. A JIT compiler provides run-time translation from byte-code instructions into machine code instructions executable on a computer processor. JIT compilers are often associated with such computer program languages as, for example, SmallTalk, Python, and Java. In a Java implementation, for example, a JIT compiler running in the Java Virtual Machine may insert instrumentation points into the prologue or epilogue of the set of instructions using the ‘redefineClass( )’ function of the Java Virtual Machine Tool Interface.

When the performance manager (100) obtains processor control, the performance manager (100) determines whether to execute the performance management function on an identified set of instructions in dependence upon historical performance data (200). The historical performance data (200) represents the performance data previously measured by performance management functions analyzing a set of instructions. In the system of FIG. 2, the historical performance data (200) is stored in a database accessible to the performance manager (100) using a database access API (212). Database access APIs useful in autonomic performance management according to embodiments of the present invention include, for example, the Open Database Connectivity (‘ODBC’) API, the Object Linking and Embedding for Databases (‘OLE DB’) API, the Java Database Connectivity (‘JDBC’) API, and so on.

When the database containing historical performance data (200) and the performance manager (100) are installed on separate computers, the performance manager (100) communicates with the database containing historical performance data (200) through a data communications connection such as, for example, a TCP/IP connection. The term ‘TCP’ stands for ‘Transmission Control Protocol.’ In TCP parlance, the endpoint of a data communications connection is a data structure called a ‘socket.’ Two sockets form a data communications connection, and each socket includes a port number and a network address for the respective data connection endpoint. Using TCP/IP, the performance manager (100) may access the historical performance data (200) through the two TCP sockets. Implementing the data communications connection with a TCP/IP connection, however, is for explanation and not for limitation. The performance manager (100) may also access the historical performance data (200) through data communications connections using other protocols such as, for example, the Internet Packet Exchange (‘IPX’) and Sequenced Packet Exchange (‘SPX’) network protocols.

The system of FIG. 2 also includes an operating system (154). The operating system is computer program instructions that provide the performance manager (100) and the application (102) low-level access to computer hardware and provide performance data to performance manager (100). In the example of FIG. 2, the operating system (154) provides low-level access to computer hardware and performance data to performance manager (100) through an operating system API (214). Functions of an operating system API useful in autonomic performance management according to embodiments of the present invention may include, for example, the UNIX ‘ioctl( )’ function with the ‘PIOCUSAGE’ command or the Win32 ‘GetThreadContext’ function.

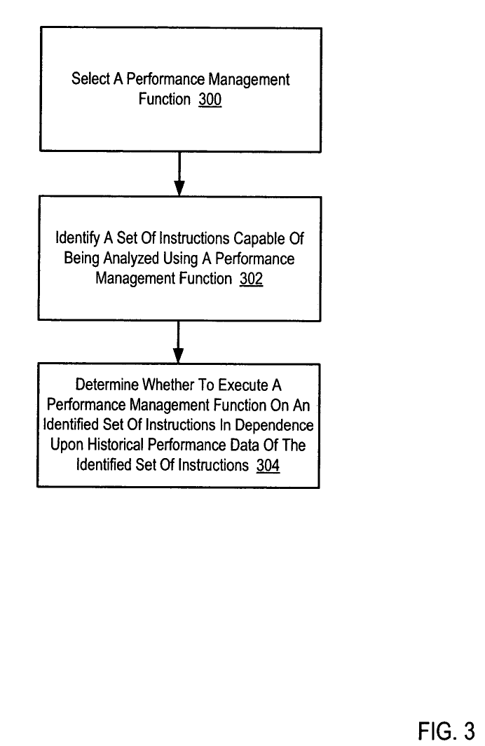

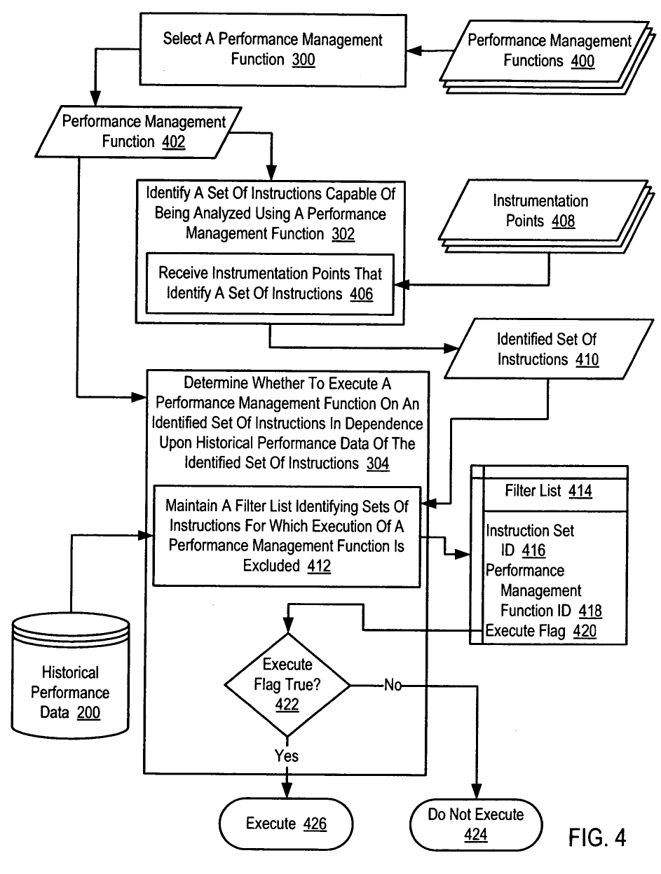

For further explanation, FIG. 3 sets forth a flow chart illustrating an exemplary method for autonomic performance management according to embodiments of the present invention that includes selecting (300) a performance management function. Selecting (300) a performance management function may be carried out as described below with reference to FIG. 4.

The method of FIG. 3 also includes identifying (302) a set of instructions capable of being analyzed using the performance management function. In the method of FIG. 3, identifying (302) a set of instructions capable of being analyzed using the performance management function may be carried out by receiving instrumentation points that identify the set of instructions. Receiving instrumentation points that identify the set of instructions may be carried out as discussed below with reference to FIG. 4.

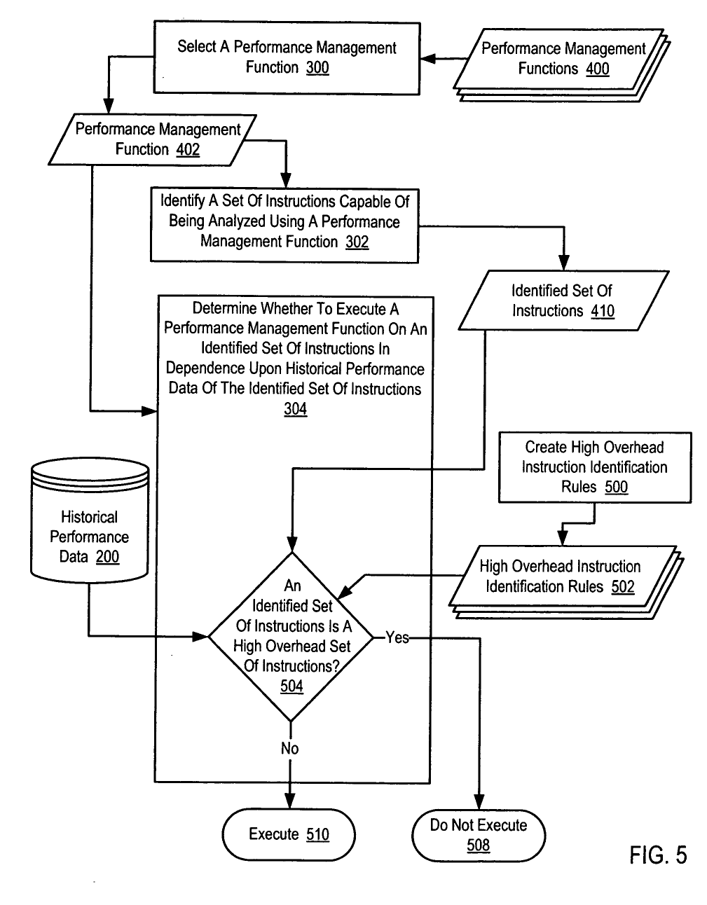

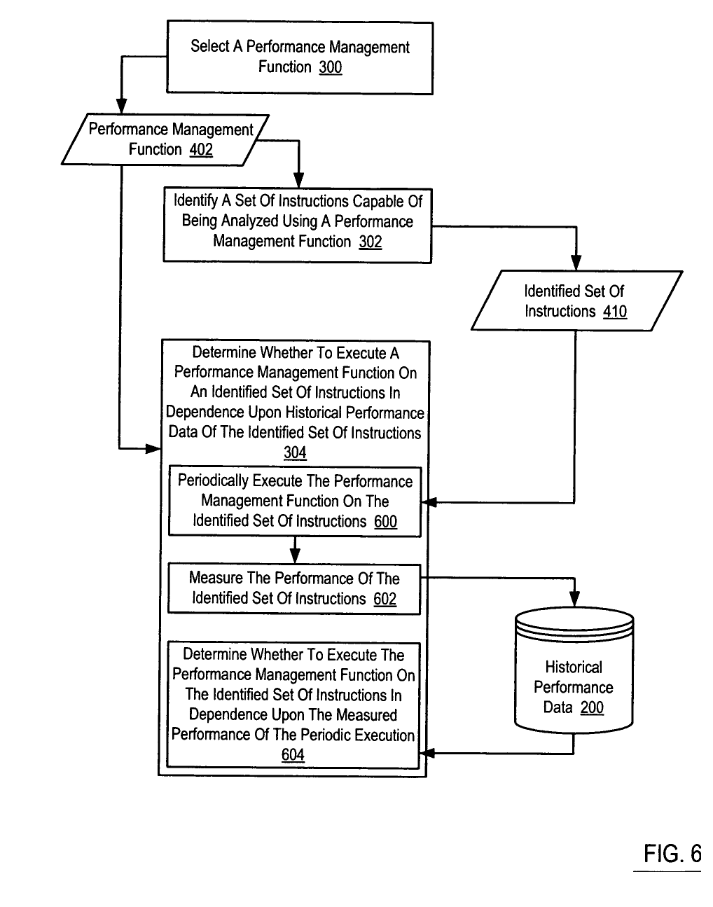

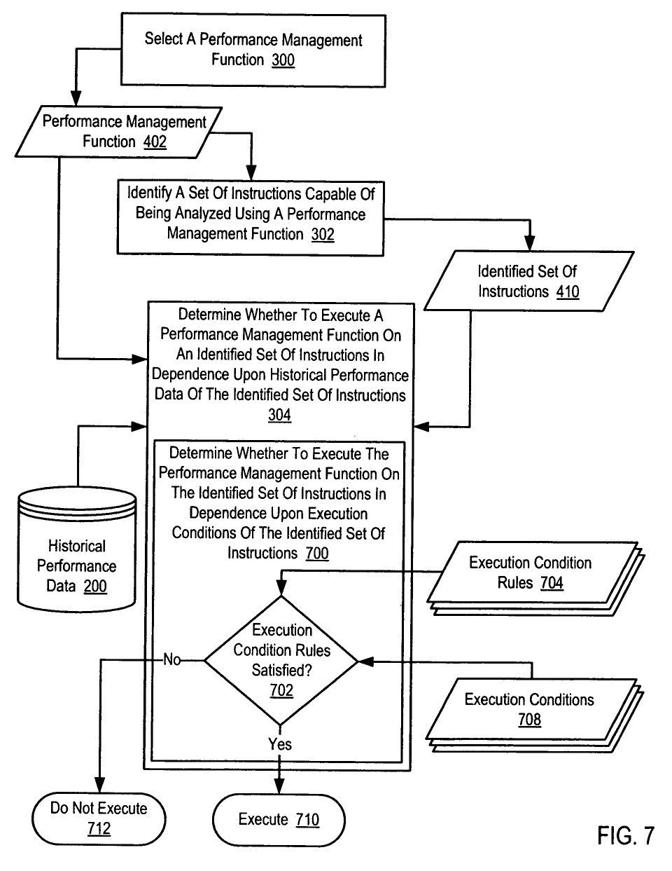

The method of FIG. 3 includes determining (304) whether to execute the performance management function on the identified set of instructions in dependence upon historical performance data of the identified set of instructions. Determining (304) whether to execute the performance management function on the identified set of instructions in dependence upon historical performance data of the identified set of instructions may be carried out by maintaining a filter list identifying sets of instructions for which the execution of the performance management function is excluded as discussed below with reference to FIG. 4. Determining (304) whether to execute the performance management function on the identified set of instructions in dependence upon historical performance data of the identified set of instructions may be carried out by determining whether the identified set of instructions is a high overhead set of instructions in dependence upon historical performance data of the identified set of instructions and high overhead instruction identification rules as discussed below with reference to FIG. 5. Determining (304) whether to execute the performance management function on the identified set of instructions in dependence upon historical performance data of the identified set of instructions may be carried out by periodically executing the performance management function on the identified set of instructions, measuring the performance of the identified set of instructions, and determining whether to execute the performance management function on the identified set of instructions in dependence upon the measured performance of the periodic execution as discussed below with reference to FIG. 6. Determining (304) whether to execute the performance management function on the identified set of instructions in dependence upon historical performance data of the identified set of instructions may be carried out by determining whether to execute the performance management function on the identified set of instructions in dependence upon historical performance data of the identified set of instructions and execution conditions of the identified set of instructions as discussed below with reference to FIG. 7.

As discussed above, identifying a set of instructions capable of being analyzed using the performance management function for autonomic performance management may be carried out by receiving instrumentation points that identify the set of instructions. For further explanation, therefore, FIG. 4 sets forth a flow chart illustrating another exemplary method for autonomic performance management according to embodiments of the present invention that includes receiving instrumentation points that identify the set of instructions. The method of FIG. 4 also includes selecting (300) a performance management function (402), identifying (302) a set of instructions capable of being analyzed using the performance management function (402), and determining (304) whether to execute the performance management function (402) on the identified set of instructions in dependence upon historical performance data (200) of the identified set of instructions (410). The performance management function (402) represents a set of computer program instructions that collects the performance data for another set of computer program instructions. The performance data may include, for example, the execution time, CPU utilization, memory utilization, input/output accesses, and so on, required to execute a set of computer program instructions.

In the example of FIG. 4, selecting (300) a performance management function (402) may be carried out by a user selecting a representation of the performance management function (402) displayed on a graphical user interface (‘GUI’) from a list representing all the available performance management functions (400). Selecting (300) a performance management function (402) may also be carried out by reading a predefined user-configuration that identified which performance management function (402) among the performance management functions (400) available to analyze a set of computer program instructions.

In the example of FIG. 4, selecting (300) a performance management function (402) may further be carried out by storing the selected performance management function (402) in a performance management definition that defines the types of performance data to collect. Storing the selected performance management function (402) in a performance management definition may be carried out using, for example, the IBM® Performance Explorer's Add Performance Explorer Definition (‘ADDPEXDFN’) command.

In the example of FIG. 4, identifying (302) a set of instructions (410) capable of being analyzed using the performance management function includes receiving (406) instrumentation points (408) that identify the set of instructions (410). The identified set of instruction (410) represents an aggregation of one or more computer program instructions into a logical group. Instrumentation points (408) represent calling instructions that transfer execution control from the prologue or epilogue of the identified set of instructions (410) of an application to a performance manager operating to perform autonomic performance management according to embodiments of the present invention. Receiving (406) instrumentation points (408) that identify the set of instructions (410) may be carried out by a processor transferring execution control from the prologue or epilogue of the identified set of instructions (410) to a performance manager operating to perform autonomic performance management according to embodiments of the present invention. A processor may transfer execution control from the identified set of instructions (410) to a performance management module using an assembly language ‘call’ instruction.

In the example of FIG. 4, determining (304) whether to execute the performance management function on the identified set of instructions (410) in dependence upon historical performance data (200) of the identified set of instructions (410) includes maintaining (412) a filter list (414) identifying sets of instructions for which the execution of the performance management function is excluded. The historical performance data (200) represents the performance data previously measured by performance management functions (400) analyzing a set of instructions. The filter list (414) is a table that associates an instruction set identifier (416) with a performance management function identifier (418) and an execute flag (420). The instruction set identifier (416) represents a particular set of instructions having historical performance data (200). The performance management function identifier (418) represents a particular performance management function for analyzing a set of instruction. The execute flag (420) represents whether a performance management function represented by the associated performance management function identifier (418) executes on the set of instructions represented by the associated instruction set identifier (416). A value indicating FALSE for the execution flag (420) represents that the performance management function represented by the associated performance management function identifier (418) does not execute on the set of instructions represented by the associated instruction set identifier (416). A FALSE value is indicated by storing a value of ‘0’ in the execution flag (420). A value indicating TRUE for the execution flag (420) represents that the performance management function represented by the associated performance management function identifier (418) executes on the set of instructions represented by the associated instruction set identifier (416). A TRUE value is indicated by storing a value of ‘1’ in the execution flag (420).

In the example of FIG. 4, determining (304) whether to execute the performance management function on the identified set of instructions (410) in dependence upon historical performance data (200) of the identified set of instructions (410) includes determining (422) whether the value of the execution flag (420) associated with the instruction set identifier (416) representing the identified set of instructions (410) and with the performance management function identifier (418) representing the performance management function (402) is TRUE. If the value of the excluded flag (420) is TRUE, then the performance management function (402) represented by the associated performance management function identifier (418) executes (426) on the identified set of instructions (410) represented by the associated instruction set identifier (416). If the value of the excluded flag (420) is FALSE, then the performance management function (402) represented by the associated performance management function identifier (418) does not execute (424) on the identified set of instructions (410) represented by the associated instruction set identifier (416).

Although the filter list (414) is depicted in the example of FIG. 4 as a table, such a depiction is for explanation and not for limitation. In fact, a filter list may in fact be implemented as a list of instruction set identifiers. Determining (304) whether to execute the performance management function on the identified set of instructions (410) in dependence upon historical performance data (200) of the identified set of instructions (410) may therefore be carried out by not executing the performance management function (402) on the identified set of instructions if the filter list includes the instruction set identifier for the identified set of instructions (410).

As discussed above, determining (304) whether to execute the performance management function on the identified set of instructions in dependence upon historical performance data of the identified set of instructions for autonomic performance management may be carried out by determining whether the identified set of instructions is a high overhead set of instructions in dependence upon historical performance data of the identified set of instructions and high overhead instruction identification rules. For further explanation, therefore, FIG. 5 sets forth a flow chart illustrating another exemplary method for autonomic performance management according to embodiments of the present invention that includes determining whether the identified set of instructions is a high overhead set of instructions in dependence upon historical performance data of the identified set of instructions and high overhead instruction identification rules. The method of FIG. 5 also includes selecting (300) a performance management function (402), identifying (302) a set of instructions capable of being analyzed using the performance management function (402), and determining (304) whether to execute the performance management function (402) on the identified set of instructions in dependence upon historical performance data (200) of the identified set of instructions (410). In the example of FIG. 5, selecting (300) a performance management function (402) may be carried out in the manner discussed above with reference to FIG. 4.

In the example of FIG. 5, identifying (302) a set of instructions (410) capable of being analyzed using the performance management function may be carried out by receiving instrumentation points that identify the set of instructions. Receiving instrumentation points that identify the set of instructions may be carried out as described with reference to FIG. 4.

The method of FIG. 5 also includes creating (500) high overhead instruction identification rules (502). A high overhead instruction identification rule (502) represents a rule that identifies a high overhead instruction based on a metric for a set of instructions using a threshold value for the metric that determines when the overhead of collecting performance data for a set of instructions using a performance management function outweighs the utility of the performance data collected. High overhead instruction identification rules (502) are useful to determine whether to execute the performance management functions (400) for a set of instructions in dependence upon historical performance data (200) of the set of instructions according to embodiments of the present invention. High overhead instruction identification rules (502) may include, for example, identifying set of instructions as high overhead when the set of instructions contains less than ten computer program instructions, when the set of instructions is executed every five milliseconds or less, and so on. In the example of FIG. 5, creating (500) high overhead instruction identification rules (502) may be carried out by receiving high overhead instruction identification rules (502) from a user operating a GUI.

For further explanation of a high overhead instruction identification rule, consider the following high overhead instruction identification rule:
IF instruction count for a set of instructions <10
THEN a set of instructions=‘high overhead.’

In the above example, a high overhead instruction identification rule dictates that a set of instructions is ‘high overhead’ if an instruction count for the set of instruction is less than ten. A high overhead instruction identification rule dictates that executing a performance management function on a set of instruction identified as ‘high overhead’ is too cumbersome.

In the example of FIG. 5, determining (304) whether to execute the performance management function on the identified set of instructions (410) in dependence upon historical performance data (200) of the identified set of instructions (410) includes determining (504) whether the identified set of instructions (410) is a high overhead set of instructions in dependence upon historical performance data of the identified set of instructions and high overhead instruction identification rules. Determining (504) whether the identified set of instructions (410) is a high overhead set of instructions may be carried out by comparing threshold values of a high overhead instruction identification rules (502) to values for the identified set of instructions stored in the historical performance database (200) for the particular metrics used by the high overhead instruction identification rules (502). If a threshold value of a high overhead instruction identification rule is greater than the value for the identified set of instructions stored in the historical performance database (200) for the particular metric used by the high overhead instruction identification rule, then the identified set of instructions (410) is a high overhead set of instructions. If a threshold value of a high overhead instruction identification rule is less than the value for the identified set of instructions stored in the historical performance database (200) for the particular metric used by the high overhead instruction identification rule, then the identified set of instructions (410) is not a high overhead set of instructions. Consider, for example, a threshold identification rule (502) that identifies a set of instructions as a high overhead set of instructions when the number of computer program instructions included in the set of instructions is less than ten. If the value for the number of instructions of the identified set of instructions (410) stored in historical performance data (200) is less than ten, then the identified set of instructions (410) is a high over set of instructions. The identified set of instructions (410) is not a high over set of instructions, however, if the value for the number of instructions of the identified set of instructions (410) stored in historical performance data (200) is greater than or equal to ten.

In the example of FIG. 5, the performance management function (402) executes (510) on the identified set of instructions (410) if the identified set of instructions (410) is not identified as a high overhead set of instruction. If the identified set of instructions (410) is identified as a high overhead set of instructions, however, the performance management function (402) does not execute (508) on the identified set of instructions (410).

Readers will notice that the methods depicted in FIGS. 3, 4, and 5 utilize historical performance data in determining whether to execution a performance management function. To obtain historical performance data, autonomic performance management according to embodiments of the present invention may also periodically execute a performance management function on an identified set of instructions and measure the performance of the identified set of instructions. For further explanation, therefore, FIG. 6 sets forth a flow chart illustrating another exemplary method for autonomic performance management according to embodiments of the present invention. The method of FIG. 6 includes selecting (300) a performance management function (402), identifying (302) a set of instructions capable of being analyzed using the performance management function (402), and determining (304) whether to execute the performance management function (402) on the identified set of instructions in dependence upon historical performance data (200) of the identified set of instructions (410). In the example of FIG. 6, selecting (300) a performance management function (402) may be carried out in the manner discussed above with reference to FIG. 4.

In the example of FIG. 6, identifying (302) a set of instructions (410) capable of being analyzed using the performance management function may be carried out by receiving instrumentation points that identify the set of instructions. Receiving instrumentation points that identify the set of instructions may be carried out as described with reference to FIG. 4.

In the example of FIG. 6, determining (304) whether to execute the performance management function on the identified set of instructions (410) in dependence upon historical performance data (200) of the identified set of instructions (410) includes periodically (600) executing the performance management function on the identified set of instructions (410). Periodically (600) executing the performance management function on the identified set of instructions (410) may be carried out by executing the performance management function on the identified set of instructions (410) every ‘N^{th}’ time the set of instructions (410) are identified (302). For example, after identifying (302) a set of instructions capable of being analyzed by a performance management function for the tenth time, the method depicted in the example of FIG. 6 may include executing the performance management function on the identified set of instructions (410) without regard to any other execution conditions such as, for example, the set of instructions being identified as a high overhead set of instruction as described with reference to FIG. 5. Periodically (600) executing the performance management function on the identified set of instructions (410) may be carried out by executing the performance management function on the identified set of instructions (410) if the performance management function has not executed on the identified set of instructions (410) within a particular time period. For example, after identifying (302) a set of instructions capable of being analyzed by a performance management function for the tenth time, the method depicted in the example of FIG. 6 may include executing the performance management function on the identified set of instructions (410) if the performance management function has not executed on the set of instructions within twenty-four hours.

In the example of FIG. 6, the determining (304) whether to execute the performance management function on the identified set of instructions (410) in dependence upon historical performance data (200) of the identified set of instructions (410) includes measuring (602) the performance of the identified set of instructions. Measuring (602) the performance of the identified set of instructions may be carried out by invoking a function of an operating system API. Invoking a function of an operating system API useful in autonomic performance management according to embodiments of the present invention may include, for example, invoking UNIX's ‘PIOCGREG’ command through the ‘ioctl( )’ function or Win32's ‘GetThreadContext’ function to obtain the value for a program counter of the process associated with the identified set of instruction (410) when the performance management function is called from the prologue or epilogue of an identified set of instructions (410). Obtaining the value of the program counter during the prologue or epilogue of an identified set of instructions allows for approximating the number of instructions contained in a particular identified set of instructions (410). Invoking a function of an operating system API useful in autonomic performance management according to embodiments of the present invention may also include, for example, invoking UNIX's ‘PIOCUSAGE’ command through the ‘ioctl( )’ function to obtain the value for the user level CPU time of the process associated with the identified set of instruction (410) when the performance management function is called from the prologue or epilogue of an identified set of instructions (410). Obtaining the value for the user level CPU time during the prologue or epilogue of an identified set of instructions allows for approximating the amount of CPU time used by a particular identified set of instructions (410). Measuring (602) the performance of the identified set of instructions may further be carried out by storing the measured performance of an identified set of instructions (410) as historical performance data (200) in a database.

In the example of FIG. 6, the determining (304) whether to execute the performance management function on the identified set of instructions (410) in dependence upon historical performance data (200) of the identified set of instructions (410) includes determining (604) whether to execute the performance management function on the identified set of instructions in dependence upon the measured performance of the periodic execution. Determining (604) whether to execute the performance management function on the identified set of instructions in dependence upon the measured performance of the periodic execution may be carried out by determining whether the identified set of instructions is a high overhead set of instructions in dependence upon the measured performance of the periodic execution. Determining whether the identified set of instructions is a high overhead set of instructions in dependence upon the measured performance of the periodic execution may be carried out in a manner similar to the method described with reference to FIG. 5. In the example of FIG. 6, if an identified set of instructions (410) is identified as a high overhead set of instructions, then the performance management function (402) does not execute on the identified set of instructions (410). The performance management function (402), however, does execute on the identified set of instructions (410) if the identified set of instructions (410) is not identified as a high overhead set of instructions.

Although the methods depicted in the examples of FIGS. 3, 4, 5, and 6 utilize historical performance data in determining whether to execute a performance management function, autonomic performance management according to embodiments of the present invention may also utilize current execution conditions in determining whether to execute a performance management function. For further explanation, therefore, FIG. 7 sets forth a flow chart illustrating another exemplary method for autonomic performance management according to embodiments of the present invention. The method of FIG. 7 includes selecting (300) a performance management function (402), identifying (302) a set of instructions capable of being analyzed using the performance management function (402), and determining (304) whether to execute the performance management function (402) on the identified set of instructions in dependence upon historical performance data (200) of the identified set of instructions (410). In the example of FIG. 7, selecting (300) a performance management function (402) may be carried out in the manner discussed above with reference to FIG. 4.

In the example of FIG. 7, identifying (302) a set of instructions (410) capable of being analyzed using the performance management function may be carried out by receiving instrumentation points that identify the set of instructions. Receiving instrumentation points that identify the set of instructions may be carried out as described with reference to FIG. 4.

In the example of FIG. 7, determining (304) whether to execute the performance management function on the identified set of instructions (410) in dependence upon historical performance data (200) of the identified set of instructions (410) includes determining (700) whether to execute the performance management function (402) on the identified set of instructions (410) in dependence upon historical performance data (200) of the identified set of instructions (410) and execution conditions (708) of the identified set of instructions (410). Execution conditions (708) represent the state of computer memory and processor registers during the time of execution of the identified set of instructions (410). In this specification, the phrase ‘during the time of execution of an identified set of instructions’ may include, for example, during the execution of the prologue or epilogue of the identified set of instructions, during the execution of the identified set of instructions themselves, or during the execution of any instructions in a call path executed during the time of execution of the identified set of instructions. Examples of execution conditions (708) may include whether debug or error logging is enabled, the state of a processor's execution stack, the state of a variable in computer memory, and so on.

In the example of FIG. 7, determining (700) whether to execute the performance management function (402) on the identified set of instructions (410) in dependence upon historical performance data (200) of the identified set of instructions (410) and execution conditions (708) of the identified set of instructions (410) may be carried out by determining (702) whether the execution conditions (708) satisfy execution condition rules (704). Execution condition rules (704) represent rules that identify whether to execute a performance management function on a set of instructions in dependence upon execution conditions of the set of instructions. An example of execution condition rules (704) may include executing a performance management function on an identified set of instructions (410) when error logging is enabled. In the example of FIG. 7, determining (702) whether the execution conditions (708) satisfy execution condition rules (704) may be carried out by obtaining execution conditions (708) through function calls to an operating system API. If the execution conditions (708) of the identified set of instructions (410) satisfy execution condition rules (704), then the performance management function (402) executes (710) on the identified set of instructions (410). The performance management function (402), however, does not execute (712) on the identified set of instructions (410) if the execution conditions (708) of the identified set of instructions (410) does not satisfy execution condition rules (704).

Exemplary embodiments of the present invention are described largely in the context of a fully functional computer system for autonomic performance management. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for autonomic performance management, the method comprising:
selecting a performance management function;
identifying a set of instructions capable of being analyzed using the performance management function; and
determining whether to execute the performance management function on the identified set of instructions in dependence upon historical performance data of the identified set of instructions.

2. The method of claim 1 wherein determining whether to execute the performance management function on the identified set of instructions in dependence upon historical performance data of the identified set of instructions further comprises maintaining a filter list identifying sets of instructions for which the execution of the performance management function is excluded.

3. The method of claim 1 further comprising creating high overhead instruction identification rules.

4. The method of claim 3 wherein determining whether to execute the performance management function on the identified set of instructions in dependence upon historical performance data of the identified set of instructions further comprises determining whether the identified set of instructions is a high overhead set of instructions in dependence upon historical performance data of the identified set of instructions and high overhead instruction identification rules.

5. The method of claim 1 wherein determining whether to execute the performance management function on the identified set of instructions in dependence upon historical performance data of the identified set of instructions further comprises determining whether to execute the performance management function on the identified set of instructions in dependence upon historical performance data of the identified set of instructions and execution conditions of the identified set of instructions.

6. The method of claim 1 wherein determining whether to execute the performance management function on the identified set of instructions in dependence upon historical performance data of the identified set of instructions further comprises:
periodically executing the performance management function on the identified set of instructions;
measuring the performance of the identified set of instructions; and
determining whether to execute the performance management function on the identified set of instructions in dependence upon the measured performance of the periodic execution.

7. The method of claim 1 wherein identifying the set of instructions capable of being analyzed using the performance management function further comprises receiving instrumentation points that identify the set of instructions.

8. An apparatus for autonomic performance management, the apparatus comprising a computer processor, a computer memory operatively coupled to the computer processor, the computer memory having disposed within it computer program instructions capable of:
selecting a performance management function;
identifying a set of instructions capable of being analyzed using the performance management function; and
determining whether to execute the performance management function on the identified set of instructions in dependence upon historical performance data of the identified set of instructions.

9. The apparatus of claim 8 wherein determining whether to execute the performance management function on the identified set of instructions in dependence upon historical performance data of the identified set of instructions further comprises maintaining a filter list identifying sets of instructions for which the execution of the performance management function is excluded.

10. The apparatus of claim 8 further comprising computer program instructions capable of creating high overhead instruction identification rules; and wherein determining whether to execute the performance management function on the identified set of instructions in dependence upon historical performance data of the identified set of instructions further comprises determining whether the identified set of instructions is a high overhead set of instructions in dependence upon historical performance data of the identified set of instructions and high overhead instruction identification rules.

11. The apparatus of claim 8 wherein determining whether to execute the performance management function on the identified set of instructions in dependence upon historical performance data of the identified set of instructions further comprises determining whether to execute the performance management function on the identified set of instructions in dependence upon historical performance data of the identified set of instructions and execution conditions of the identified set of instructions.

12. The apparatus of claim 8 wherein determining whether to execute the performance management function on the identified set of instructions in dependence upon historical performance data of the identified set of instructions further comprises:
periodically executing the performance management function on the identified set of instructions;
measuring the performance of the identified set of instructions; and
determining whether to execute the performance management function on the identified set of instructions in dependence upon the measured performance of the periodic execution.

13. A computer program product for autonomic performance management, the computer program product disposed upon a signal bearing medium, the computer program product comprising computer program instructions capable of:
selecting a performance management function;
identifying a set of instructions capable of being analyzed using the performance management function; and
determining whether to execute the performance management function on the identified set of instructions in dependence upon historical performance data of the identified set of instructions.

14. The computer program product of claim 13 wherein the signal bearing medium comprises a recordable medium.

15. The computer program product of claim 13 wherein the signal bearing medium comprises a transmission medium.

16. The computer program product of claim 13 wherein determining whether to execute the performance management function on the identified set of instructions in dependence upon historical performance data of the identified set of instructions further comprises maintaining a filter list identifying sets of instructions for which the execution of the performance management function is excluded.

17. The computer program product of claim 13 further comprising creating high overhead instruction identification rules; and wherein determining whether to execute the performance management function on the identified set of instructions in dependence upon historical performance data of the identified set of instructions further comprises determining whether the identified set of instructions is a high overhead set of instructions in dependence upon historical performance data of the identified set of instructions and high overhead instruction identification rules.

18. The computer program product of claim 13 wherein determining whether to execute the performance management function on the identified set of instructions in dependence upon historical performance data of the identified set of instructions further comprises determining whether to execute the performance management function on the identified set of instructions in dependence upon historical performance data of the identified set of instructions and execution conditions of the identified set of instructions.

19. The computer program product of claim 13 wherein determining whether to execute the performance management function on the identified set of instructions in dependence upon historical performance data of the identified set of instructions further comprises:
periodically executing the performance management function on the identified set of instructions;
measuring the performance of the identified set of instructions; and
determining whether to execute the performance management function on the identified set of instructions in dependence upon the measured performance of the periodic execution.

20. The computer program product of claim 13 wherein identifying the set of instructions capable of being analyzed using the performance management function further comprises receiving instrumentation points that identify the set of instructions.
